(19) United States
(12) Patent Application Publication
(10) Pub. No.: US 2012/0187839 A1
(43) Pub. Date: Jul. 26, 2012

(54) LUMINOUS MEANS

(75) Inventors: Andreas HAMMEL, Wenzenbach (DE); Martin BACHHUBER, Altdorf (DE); Ralph PATZOLD, Roth (DE)

(73) Assignee: DIEHL AEROSPACE GMBH, Ueberlingen (DE)

(21) Appl. No.: 13/348,937

(22) Filed: Jan. 12, 2012

(30) Foreign Application Priority Data
Jan. 21, 2011 (DE) 10 2011 009108.4

(51) Int. Cl. B60Q 3/02

(52) U.S. Cl. 315/77

(57) ABSTRACT

A luminous device is provided comprising LEDs with an LED controller for adjusting a luminous characteristic of the LEDs, and a data receiver (10). The data receiver (10), is connected to the LED controller (9), for wireless reception of data (D). The controller (4) is configured in such a way that, in predetermined switching stage (S3) of the controller (4), the data receiver (10) can be or is activated, and in the case of an activated data receiver (10), the luminous characteristic of the LEDs (3) can be adjusted exclusively by the LED controller (9) depending on data (D) received by the data receiver (10).

### BACKGROUND OF THE INVENTION

The invention relates to a luminous means for lighting a cabin, in particular a cabin of a land vehicle or aircraft.

### DISCUSSION OF THE PRIOR ART

In accordance with the prior art, fluorescent tubes are used in particular for lighting aircraft cabins. Such fluorescent tubes are provided with a luminous device which is surrounded by a housing which is configured in such a way that at least a section of said housing is transparent. In addition, a controller is provided in the housing, said controller enabling stepwise adjustment of a brightness of the luminous device. The on-board power supply system of an aircraft comprises two signal lines, which are connected to the controller via first contacts provided on the housing of the luminous means. In addition, the luminous means is also connected to a power supply via second contacts provided on the housing. By means of the controller, the luminous means can be switched off completely during takeoff or landing or operated at maximum brightness in the event of an emergency.

Conventional fluorescent tubes consume a relatively high power. The light generated thereby can be adjusted stepwise only with respect to its brightness.

In accordance with the prior art, in addition so-called “replacement tubes” are known, in which the luminous device is formed by LEDs. LED luminous devices are conventionally provided with a relatively complex LED controller, which enables the adjustment of a luminous characteristic of the LEDs. Such “replacement tubes” are not suitable, however, for replacing fluorescent tubes in aircraft cabins since the signal lines provided there do not enable driving of the LED controller. In the case of the use of “replacement tubes” in the sector of aircraft cabins, it is therefore necessary to modify or replace the on-board power supply system in terms of the power supply and the signal lines for the luminous means. This results in a high level of costs and time expenditure.

### SUMMARY OF THE INVENTION

The object of the invention is to eliminate the disadvantages in accordance with the prior art. In particular, the invention specifies a luminous means which can be used as a replacement for conventional fluorescent tubes without a high level of complexity being involved. In accordance with a further aim of the invention, the luminous means can be used in particular as a replacement for conventional fluorescent tubes in the sector of aircraft cabins and should meet the safety requirements relevant for this sector.

This object is achieved by the features of Claims 1 and 9. Expedient configurations of the invention result from the features of Claims 2 to 8 and 10 to 15.

The invention provides that the luminous device comprises LEDs with an LED controller for adjusting a luminous characteristic of the LEDs, wherein a data receiver, which is connected to the controller and the LED controller, for wireless reception of data is provided and the controller is configured in such a way that, in a predetermined switching stage of the controller, the data receiver can be or is activated, and in the case of an activated data receiver, the luminous characteristic of the LEDs can be adjusted exclusively by the LED controller depending on data received by the data receiver.

In the context of the present invention, the term “data” is generally understood to mean signals which encode information items, in particular digital information items.

According to the invention, therefore, the signals which can be transmitted via the conventional signal lines for adjusting different brightness levels in a conventional fluorescent tube are used, in the luminous means according to the invention, to activate a data receiver provided therein or to make said data receiver activatable, for example by means of wirelessly transmitted data. In this case, the basic switching priority of the signals transmitted via the signal lines remains the same. That is to say that the data receiver can be deactivated or switched off again by the signals transmitted via the signal line. If, for example, it was conventionally the case that four switching states could be adjusted using the signals transmitted via the signal lines, in accordance with the subject matter of the present invention, these switching states can be maintained. One of the switching states is now used to activate or make activatable the data receiver. The three remaining switching states, as in the case of the use of fluorescent tubes, can be used for adjusting a predetermined brightness of the luminous means. For example, in the event of takeoff or landing of the aircraft, a conventional switching state can be adjusted, in which the luminous means is completely switched off.

The use of the luminous means according to the invention does not necessitate any change to the on-board power supply system or the conventional holders for the fluorescent tubes. Nevertheless, the luminous means makes it possible to save energy and at the same time enables substantially more extensive adjustment of the luminous characteristic owing to the use of a luminous device comprising LEDs.

Advantageously, the controller has two first contacts for connecting two control lines. The housing, the first contacts provided thereon and second contacts provided thereon for the power supply are expediently configured correspondingly to a conventional fluorescent tube. This makes it possible to directly replace conventional fluorescent tubes with the luminous means according to the invention.

Advantageously, the adjustment of the luminous characteristic by means of the data receiver comprises an adjustment of at least one of the following parameters: brightness, colour, colour temperature, colour rendering index. That is to say that the adjustment of the luminous characteristic goes far beyond the conventional adjustment of the parameter “brightness”. By adjusting the luminous characteristic the light generated by the luminous means can be matched in optimum fashion to the respective environmental conditions or requirements.

In accordance with a particularly advantageous configuration, the data receiver is provided with a specific address. It is thus possible, in the event of the activation of the data receiver, to supply specifically data relating to the adjustment of the luminous characteristic to said data receiver. That is to say that the luminous characteristic of each luminous means can thus be adjusted individually. It is of course also possible for a plurality of luminous means to be combined in groups and for a luminous characteristic of such luminous means to be altered in groups. For example, a luminous characteristic of the luminous means provided in a first class compartment of an aircraft can be adjusted differently than a luminous characteristic of the luminous means provided in a second class compartment.

Expediently, the data receiver is suitable for receiving data transmitted by means of radio or optical or acoustic signal transmission. In accordance with a further advantageous configuration, the data receiver is a first data transceiver. It is thus possible to transmit information items relating to a function state to a second data transceiver. In particular, information items relating to faulty operation of the luminous means can be transmitted to a second data transceiver. On the basis of such an item of information, the luminous means can be switched off, for example.

The invention also proposes a luminous device for lighting a cabin, in particular a cabin of a land vehicle or aircraft, comprising a luminous means according to the invention, which is connected to a lighting controller by signal lines, and a data transmitter for transmitting the data for adjusting the luminous characteristic to the data receiver.

In the case of an aircraft cabin, the luminous device according to the invention makes use of a conventional installation for fluorescent tubes, i.e. it is possible in particular for the already existing on-board power supply system with power supply lines and signal lines, the holders for the fluorescent tubes and the conventional lighting controller connected to the signal lines to be used. For the operation of the luminous means according to the invention, however, a data transmitter for transmitting the data for adjusting the luminous characteristic to the data receiver accommodated in the luminous means is also included. On the basis of a conventional luminous device, in which conventional fluorescent tubes are used, the luminous device according to the invention can be produced in a relatively simple manner. For this purpose, only the conventional fluorescent tubes need to be replaced by the luminous means according to the invention, and the data transmitter also needs to be provided. Expediently, the data transmitter is integrated in the lighting controller or is connected to the lighting controller, with the result that data can therefore advantageously only be transmitted when the data receiver has already been activated or made activatable by means of the controller.

Advantageously, the luminous means according to the invention is accommodated in a conventional holder for a fluorescent tube. Such a conventional holder comprises first mating contacts, which correspond to the first contacts, and second mating contacts, which correspond to the second contacts. That is to say that when the luminous means according to the invention is inserted properly into the conventional holder, an electrical connection between the first contacts and the first mating contacts and between the second contacts and the second mating contacts is produced. The luminous means is thus connected to the power supply and to the signal lines.

In a further advantageous configuration, a plurality of luminous means is provided, with each of the data receivers of said luminous means being provided with a specific address. In this case, a luminous characteristic of each of the luminous means can be adjusted individually by means of the data transmitter. It is thus possible to produce complex lighting scenarios within a cabin. For this purpose, the data transmitted by the data transmitter are advantageously generated by means of a predetermined computer program. Different lighting scenarios can therefore be produced easily and quickly. It is possible for different lighting scenarios to be produced at different locations in the cabin at the same time.

The data transmitter transmits the data by means of radio or optical or acoustic signal transmission, for example. In the event of signal transmission with a range which is not excessively great, it is also possible for a plurality of data transmitters to be provided at different locations in the cabin. It is also possible to provide mobile data transmitters in the form of remote control.

In accordance with a further advantageous configuration, the data transmitter is configured as a second data transceiver. The information items relating to a function state of the luminous means can be received by such a second data transceiver. It is thus possible, for example, to establish quickly and easily whether there is an operational fault in a luminous means. This facilitates maintenance and repair of the luminous device.

### BRIEF DESCRIPTION OF THE DRAWINGS

Exemplary embodiments of the invention will be explained in more detail below with reference to the drawing, in which:

FIG. 1 shows a schematic illustration of the luminous means,

FIG. 2 shows a schematic block circuit diagram of the controller and the LED controller, and

FIG. 3 shows a schematic illustration of a luminous device.

### DETAILED DESCRIPTION OF THE INVENTION

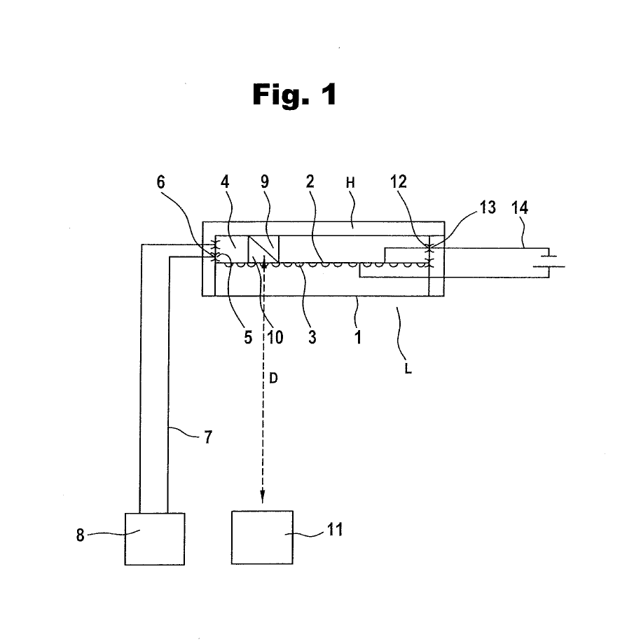

In FIG. 1, a luminous means which is generally denoted by the reference symbol L is accommodated in a holder H. The luminous means L has a housing 1, for example a tubular housing, in which a luminous device 2 is accommodated which has a large number of LEDs 3 for generating light. The reference symbol 4 denotes a controller accommodated in the housing 1. First contacts 5 of the controller 4 are in electrical contact with first mating contacts 6, which connect signal lines 7 to a lighting controller 8.

The reference symbol 9 denotes an LED controller which is connected to a data receiver 10 for wireless reception of data. The data receiver 10 can be in the form of a first data transceiver, which is suitable both for receiving and transmitting data.

Reference symbol 11 denotes a data transmitter for wireless transmission of the data D. The data transmitter 11 can be a second data transceiver, which is suitable for both transmitting and receiving data D.

The luminous device 2 is also connected to power supply lines 14 via second contacts 12 and second mating contacts 13, which are electrically connected to said second contacts 12.

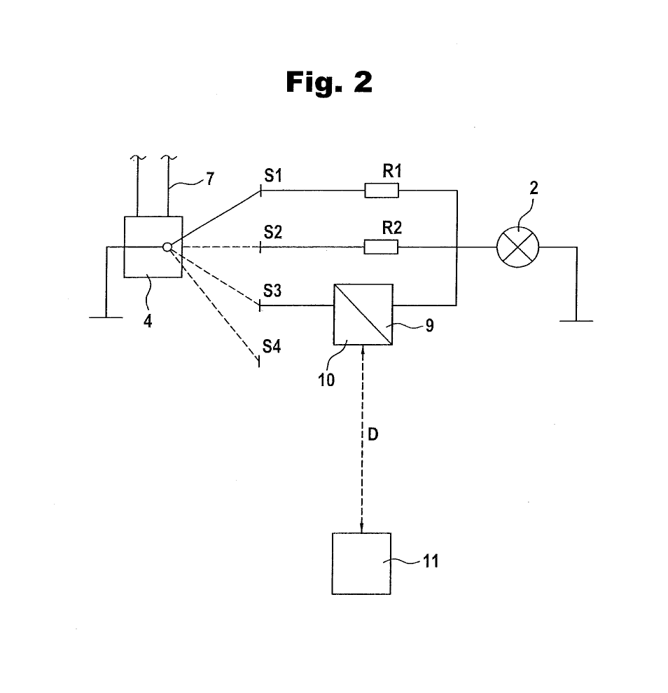

FIG. 2 shows, schematically, the mode of operation of the controller 4 and the LED controller 9. By means of signals transmitted via the signal lines 7, as are used for driving conventional fluorescent tubes, alternatively four switching states S1, S2, S3, S4, for example, can be adjusted by the controller 4.

In the first switching state S1, the luminous device 2 is supplied with current via a first resistor R1. Depending on the resistance of the first resistor R1, operation of the luminous device 2 at a first brightness results.

In a similar manner, in the second switching state S2, the luminous device 2 is supplied with power via a second resistor R2. Depending on the resistance of the second resistor R2, the luminous device 2 can be operated at a second brightness.

In the third switching state S3, the LED controller 9 and the data receiver 10, connected thereto, are activated or switched on. The data receiver 10 is suitable for receiving data D or data signals, with which a plurality of parameters for influencing the luminous characteristic of the luminous device 2 can be adjusted via the LED controller 9. The parameters may be the brightness, colour, colour temperature, colour rendering index or the like.

The schematic circuit shown in FIG. 2 can of course also have a different configuration. The controller 4, the LED controller 9 and the data receiver 10 can be in the form of an integrated circuit. The switching states S1, S2, S3, S4, the brightnesses and the other functions can also be produced digitally. In any event, however, it is the case that the control signals transmitted via the signal lines 7 have a higher priority than the data D transmitted wirelessly by the data transmitter. That is to say that in any event the data receiver 10 can be switched on or off by suitable driving of the controller 4.

In the fourth switching state S4, the brightness is “zero”, i.e. the luminous device 2 is switched off.

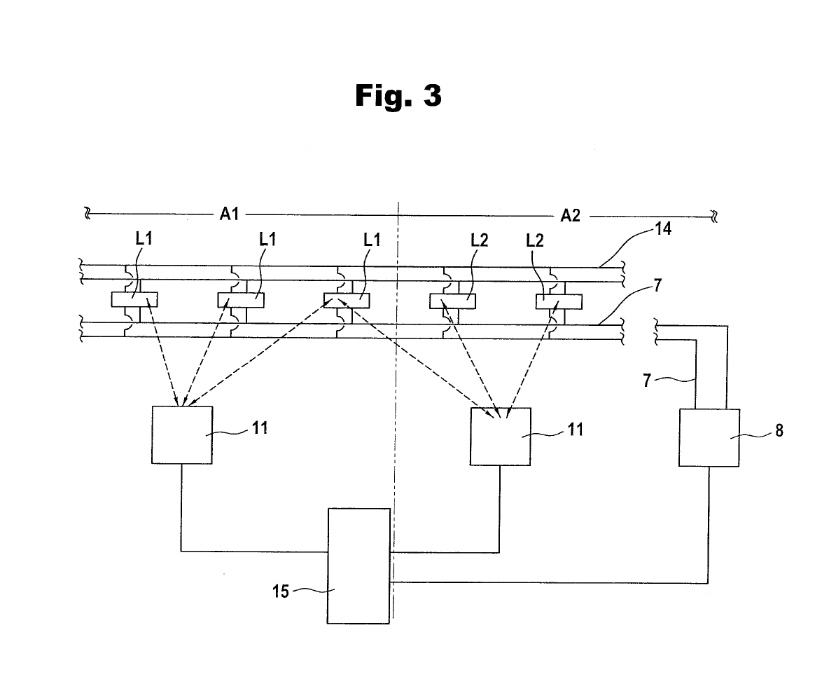

FIG. 3 shows a schematic illustration of a luminous device for lighting a cabin. A plurality of luminous means L are supplied with power by power supply lines 14 of an on-board power supply system (not shown here). The luminous means L are also connected to the lighting controller 8 via the signal lines 7. The lighting controller 8 can be connected to a central control computer 15, in the same way as the data transmitter 11,

The first luminous means L1 are located in a first section A1 of the cabin (not shown here), said first section being delimited by the dash-dotted line. The second luminous means 12 are located in a second section A2 of the cabin. The first luminous means L1 have a common specific first address and the second luminous means L2 have a common specific second address.

In accordance with a predetermined control program running on the control computer 15, data D are transmitted continuously to the first luminous means L1 and the second luminous means L2 from the data transmitters 11. A first portion of the data is specific to the first address and a second portion of the data is specific to the second address. As a result, different lighting scenarios can be produced by means of the first luminous means L1 and the second luminous means L2 in the first section A1 and the second section A2 of the cabin.

In order to simplify the control, the lighting controller 8 can also be connected to the control computer 15. As a result, all of the control commands can be generated centrally by means of the control computer 15.

### LIST OF REFERENCE SYMBOLS

1 Housing
2 Luminous device
3 LED
4 Controller
5 First contact
6 Second contact
7 Signal line
8 Lighting controller
9 LED controller
10 Data receiver
11 Data transmitter
12 Second contact
13 Second mating contact
14 Power supply line
15 Control computer
L Luminous means
L1, L2 First, second luminous means
H Holder
S1 First switching state
S2 Second switching state
S3 Third switching state
S4 Fourth switching state
R1 First resistor
R2 Second resistor
D Data
A1 First section
A2 Second section

What is claimed is:

1. Luminous means (L, L1, L2) for lighting a cabin, in particular a cabin of a land vehicle or aircraft, in which a luminous device and a controller which can be driven via signal lines for the stepwise adjustment of a brightness of the luminous device are accommodated in a housing, at least a section of said housing being transparent, characterized in that the luminous device comprises LEDs with an LED controller for adjusting a luminous characteristic of the LEDs, wherein a data receiver, which is connected to the LED controller, for wireless reception of data (D) is provided and the controller is configured in such a way that, in a predetermined switching stage (S3) of the controller, the data receiver can be or is activated, and in the case of an activated data receiver, the luminous characteristic of the LEDs can be adjusted exclusively by the LED controller depending on data (D) received by the data receiver.

2. Luminous means according to claim 1, wherein the controller has two first contacts for connecting two control lines.

3. Luminous means according to claim 2, wherein the housing, the first contacts provided thereon and second contacts provided thereon for the power supply are configured correspondingly to a conventional fluorescent tube.

4. Luminous means according to claim 1, wherein the adjustment of the luminous characteristic by means of the data receiver comprises an adjustment of at least one of the following parameters: brightness, colour, colour temperature, colour rendering index.

5. Luminous means according to claim 1, wherein the data receiver is provided with a specific address.

6. Luminous means according to claim 1, wherein the data receiver is suitable for receiving data (D) transmitted by means of radio or optical or acoustic signal transmission.

7. Luminous means according to claim 1, wherein the data receiver is a first data transceiver.

8. Luminous means according to claim 1, wherein information items relating to a function state can be transmitted to a second data transceiver by the first data transceiver.

9. Luminous device for lighting a cabin, in particular a cabin of a land vehicle or aircraft, comprising a luminous means (L, L1, L2) according to claim 1, which is connected to a lighting controller by signal lines, and a data transmitter for transmitting the data (D) for adjusting the luminous characteristic to the data receiver.

10. Luminous device according to claim 9, wherein the controller of the luminous means (L, L1, L2) has two first contracts for connecting two control lives and is accommodated in a conventional holder (H) for a fluorescent tube.

11. Luminous device according to claim 9, wherein a plurality of luminous means (L, L1, L2) is provided wherein the adjustment of the luminous characteristic by means of the data receiver comprises an adjustment of at least one of the following parameters: brightness, color, color temperature, color rendering index, and wherein a luminous characteristic of each of the luminous means (L, L1, L2) can be adjusted individually by means of the data transmitter.

12. Luminous device according to claim 9, wherein the data (D) transmitted by the data transmitter are generated by means of a predetermined computer program.

13. Luminous device according to claim 9, wherein the data transmitter transmits the data (D) by means of radio or optical or acoustic signal transmission.

14. Luminous device according to claim 9, wherein the data transmitter is a second data transceiver.

15. Luminous device according to claim 9, wherein the information items relating to a function state of the luminous means are received by the second data transceiver.
